(19) United States
(12) Patent Application Publication
(10) Pub. No.: US 2023/0333668 A1
(43) Pub. Date: Oct. 19, 2023

(54) TRANSLATE A HAND GESTURE TO AN ACTION

(71) Applicant: Hewlett-Packard Development Company, L.P., Spring, TX (US)

(72) Inventors: Keith A. Fish, Fort Collins, CO (US); Fred Charles Thomas, III, Fort Collins, CO (US)

(73) Assignee: Hewlett-Packard Development Company, L.P., Spring, TX (US)

(21) Appl. No.: 18/042,191

(22) PCT Filed: Aug. 28, 2020
(86) PCT No.: PCT/US2020/048505

§ 371 Date: Feb. 17, 2023

(51) Int. Cl. G06F 3/023; G06F 3/01

(52) U.S. Cl. CPC G06F 3/023; G06F 3/017

(57) ABSTRACT

Translating a hand gesture to an action, consistent with the present disclosure, may be performed in a number of ways. In a particular example, a computer-readable medium may store instructions that when executed cause a processor to receive from a sensor of an input device, a drive signal indicative of a hand gesture, where the drive signal is a sigma-delta A-to-D enabled drive signal. The computer-readable medium may also store instructions that when executed, cause the processor to instruct the input device to enter a hover mode of operation, in response to a determination that the hand gesture includes a first hand gesture, and translate a second hand gesture detected by the sensor to an action by determining a three-dimensional space position and a motion vector of the second hand gesture. The computer-readable medium may store instructions, provide instructions to an operating system to perform the action.

### BACKGROUND

A computer mouse is a hand-held input device for computers that detects motions relative to a surface. The motion is translated into motion of a pointer on a display, often referred to as a cursor, and allows for control of a graphical user interface. A computer mouse may be wired or cordless, in many instances.

### BRIEF DESCRIPTION OF THE DRAWINGS

FIG. 1 illustrates an example block diagram of a computing device including instructions to translate a hand gesture to an action, consistent with the present disclosure.

FIG. 2 illustrates an example block diagram of a computing device including instructions for translating a hand gesture to an action, consistent with the present disclosure.

FIG. 3 illustrates an example apparatus, for translating a hand gesture to an action, consistent with the present disclosure.

FIG. 4 illustrates an example flow diagram of a method, for translating a hand gesture to an action, consistent with the present disclosure.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

Use of computing devices such as personal computers and clamshell notebooks involve use of a keyboard and mouse or trackpad as user-input devices. In many instances, it may be advantageous to provide input to the computing device without the use of the keyboard, mouse, or a trackpad. Users of mobile devices may avoid using a trackpad on their device and instead use a mouse coupled to their mobile device because the trackpad is inconsistent in usability. Users keying (e.g., typing) input on a keyboard may transition one hand frequently between the keyboard and the mouse or trackpad of their computing device. Frequent transitions between the keyboard to the mouse or trackpad slows down user input into their workflow and could lead to additional physical stress or injury to the wrist, hands, and forearm. Accordingly, providing input to the computing device without use of a mouse or a trackpad may reduce the risk of physical stress or injury and increase user efficiency.

Translating a hand gesture to an action, consistent with the present disclosure, may be performed in a number of ways. In a particular example, a computer-readable medium may store instructions that when executed cause a processor to receive, from a sensor of an input device, a drive signal indicative of a hand gesture, where the drive signal is a sigma-delta analog-to-digital (A-to-D) enabled drive signal. The computer-readable medium may also store instructions that when executed, cause the processor to instruct the input device to enter a hover mode of operation, in response to a determination that the hand gesture includes a first hand gesture, and translate a second hand gesture detected by the sensor to an action by determining a three-dimensional space position and a motion vector of the second hand gesture. The computer-readable medium may store instructions, provide instructions to an operating system to perform the action.

As an additional example, a computer-readable medium may store instructions that when executed, cause a processor to receive from a sensor of an input device, a drive signal indicative of a hand gesture. The computer-readable medium may store instructions to perform a sigma-delta conversion of the drive signal, and compare positional features of the hand gesture to a plurality of specified hand gestures corresponding with a hover mode of operation of the input device. The computer-readable medium may also store instructions that when executed, cause the processor to classify the hand gesture as one of a plurality of specified hand gestures based on the comparison. The computer-readable medium may store instructions to translate the hand gesture to an action on a display communicatively coupled to the processor by determining a three-dimensional space position and a motion vector of the hand gesture, and provide instructions to an operating system to perform the action.

As a further example, an apparatus for translating a hand gesture to an action comprises an input device including a sensor. The sensor may detect an electrical change indicative of a hand gesture, and responsive to the detection of the electrical change, produce a drive signal corresponding with the hand gesture. The apparatus may further include a controller to perform a sigma-delta conversion of the drive signal received from the input device, and to instruct the input device to enter a hover mode of operation, in response to a determination that the hand gesture includes a first hand gesture. The controller may translate a second hand gesture detected by the sensor to an action on a display, and provide instructions to an operating system of the apparatus to perform the action. By providing input to the computing device without use of a mouse or a trackpad, examples of the present disclosure may reduce the risk of physical stress or injury and increase user efficiency.

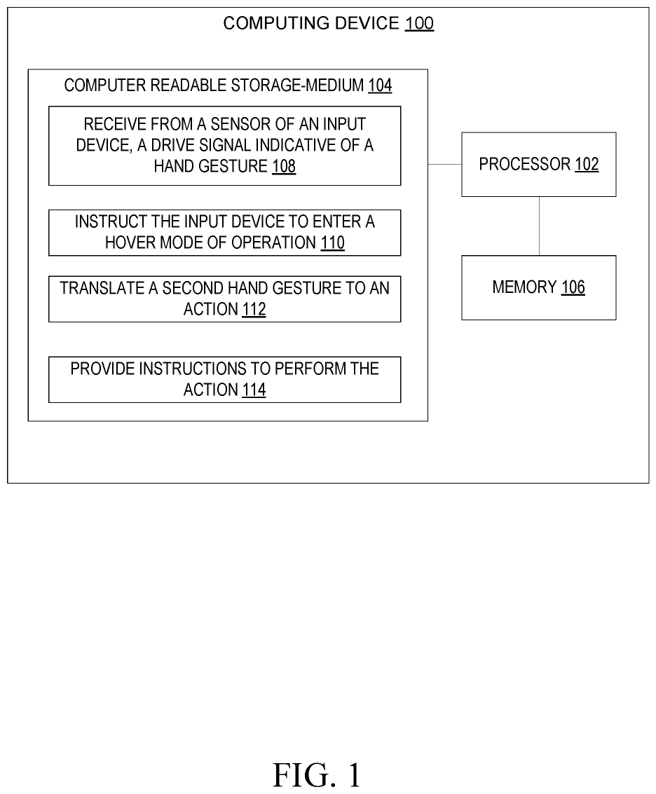

Turning now to the figures, FIG. 1 illustrates an example block diagram of a computing device 100 including instructions to translate a hand gesture to an action, consistent with the present disclosure. As illustrated in FIG. 1, the computing device 100 may include a processor 102, a computer-readable storage medium 104, and a memory 106.

The processor 102 may be a central processing unit (CPU), a semiconductor-based microprocessor, and/or other hardware device suitable to control operations of the computing device 100. Computer-readable storage medium 104 may be an electronic, magnetic, optical, or other physical storage device that contains or stores executable instructions. Thus, computer-readable storage medium 104 may be, for example, Random Access Memory (RAM), an Electrically Erasable Programmable Read-Only Memory (EEPROM), a storage device, an optical disc, etc. In some examples, the computer-readable storage medium may be a non-transitory storage medium, where the term ‘non-transitory’ does not encompass transitory propagating signals. As described in detail below, the computer-readable storage medium 104 may be encoded with a series of executable instructions 108-114. In some examples, computer-readable storage medium 104 may implement a memory 106. Memory 106 may be any non-volatile memory, such as EEPROM, flash memory, etc.

As illustrated, the computer-readable storage medium 104 may store instructions 108 that when executed, cause a processor 102 to receive from a sensor of an input device, a drive signal indicative of a hand gesture, wherein the drive signal is a sigma-delta A-to-D enabled drive signal. For instance, as a hand is moved over a particular region of the computing device, a drive signal may be generated. The drive signal may be a sigma-delta A-to-D enabled drive signal. As used herein, a sigma-delta A-to-D enabled drive signal refers to or includes a drive signal that is capable of sigma-delta modulation. Sigma-delta modulation is a method for encoding analog signals into digital signals as found in an analog-to-digital converter (ADC). It is also used to convert high bit-count, low-frequency digital signals into lower bit-count, higher-frequency digital signals as part of the process to convert digital signals into analog as part of a digital-to-analog converter (DAC). In delta modulation, the change in the signal (or “delta”) is encoded, rather than the absolute value. The result is a stream of pulses, as opposed to a stream of numbers as is the case with pulse code modulation (PCM). In delta-sigma modulation, accuracy of the modulation is improved by passing the digital output through a 1-bit DAC and adding (sigma) the resulting analog signal to the input signal (the signal before delta modulation), thereby reducing the error introduced by the delta modulation.

Both ADCs and DACs can employ delta-sigma modulation. A delta-sigma ADC first encodes an analog signal using high-frequency delta-sigma modulation, and then applies a digital filter to form a higher-resolution but lower sample-frequency digital output. A delta-sigma DAC encodes a high-resolution digital input signal into a lower-resolution but higher sample-frequency signal that is mapped to voltages, and then smoothed with an analog filter. In both cases, the temporary use of a lower-resolution signal simplifies circuit design and improves efficiency.

The computer-readable storage medium 104 further includes instructions 110 that when executed, cause the processor 102 to instruct the input device to enter a hover mode of operation, in response to a determination that the hand gesture includes a first hand gesture. As used herein, a hover mode of operation refers to or includes a functioning state of the computing device 100, in which motion of a hand or other object, as sensed by the sensor of the input device, is used to control operations of the computing device 100 instead of a mouse. As an example, while the hand is hovering above the input device and within a threshold distance of the sensor, a particular motion such as a wave may be detected which indicates that the input device is to enter the hover mode of operation. While in the hover mode of operation, hand motions detected by the input device may be detected and used to move a cursor on a display, select objects on a display, perform operations with the computing device 100, and to respond to stimuli from the computing device 100. The hover mode of operation may terminate in response to the sensor detecting a hand gesture associated with terminating the hover mode of operation, or in response to other termination events as discussed further herein.

While a wave of a hand is provided as an example of a hand gesture signaling initiation of the hover mode of operation, examples are not so limited. Any hand gesture or combination of hand gestures may be associated with the initiation of the hover mode of operation. For instance, in some examples, the position of each finger is determined by the sensor of the input device, and a particular position and relative motion of each finger may be used to determine when the input device is to enter the hover mode of operation. In such examples, the first hand gesture includes a particular finger motion, and the instructions 110 to enter the hover mode of operation include instructions to initiate the hover mode of operation responsive to detecting the particular finger motion.

The computer-readable storage medium 104 further includes instructions 112 that when executed, cause the processor 102 to translate a second hand gesture detected by the sensor to an action by determining a three-dimensional space position and a motion vector of the second hand gesture. Once the input device is in the hover mode of operation, hand motions detected by the sensor of the input device may be compared to particular hand gestures associated with specified functions to be performed by the computing device 100. For instance, in various examples the input device includes a keyboard, and the sensor includes a projected capacitive array film disposed beneath the keyboard. The sensor may detect motion above the keys of the keyboard, and also at particular locations on the computing device 100 such as below the space bar. In such examples, the computing device 100 may enter the hover mode of operation responsive to the sensor detecting that a left thumb touched a particular region below the space bar of the keyboard. Once in the hover mode of operation, a relative mouse movement may be generated responsive to the sensor detecting a right index finger moving over the keys of the keyboard (e.g., the input device). The movement of the hand over the keys (e.g., a second hand gesture) may determine the relative motion of the cursor or mouse on a display. In such examples, the medium 104 includes instructions that when executed, cause the processor 102 to provide instructions to the operating system to move a cursor on a display in a motion corresponding with the second hand gesture. Similarly, the second hand gesture may include a particular motion of a combination of fingers. In such examples, the medium 104 includes instructions that when executed, cause the processor 102 to select an object on a user interface on the display responsive to detecting the second hand gesture.

As another example of a hand gesture, a left-button mouse click may be generated responsive to the sensor detecting a right thumb is pressed against an index finger. Moreover, a double mouse-click may be generated responsive to the sensor detecting a right thumb quickly tapping the right index finger a specified number of times, such as two times. While various examples are provided for different hand gestures that may be detected by the sensor of the input device, examples are not limited to those provided. The association of a particular hand gesture with a particular action on the computing device 100 is customizable, and may be different and/or in addition to operations performed by a mouse.

The computer-readable storage-medium 104 also includes instructions 114 that when executed, cause the processor 102 to provide instructions to an operating system to perform the action. As discussed with regards to instructions 112, each respective hand gesture may be associated with a different action on the computing device 100. Non-limiting examples of actions include a movement of a mouse or cursor on a display of the computing device, effecting a mouse left-button click, effecting a double-mouse click, and effecting a mouse right-button click, among others. Additional and/or different actions may be specified by a user for a customized mapping of hand gestures to computing device actions.

As discussed herein, the input device may include a keyboard. In some examples, motion may be detected over a subset of the keys of the keyboard. In such examples, the medium 104 includes instructions that when executed, cause the processor 102 to detect movement of a particular finger over the subset of keys of the keyboard.

Although examples are discussed herein with regards to a keyboard, the input device is not limited to examples using a keyboard. In some examples, the input device may include a touchpad and/or a mouse, among other input devices. In such examples, motion may be detected over a surface of the input device, and the processor 102 may detect movement of a particular finger over the surface of the input device.

The computer-readable storage medium 104 is not limited to the instructions illustrated in FIG. 1, and additional and/or different instructions may be stored and executed by processor 102 and/or other components of computing device 100.

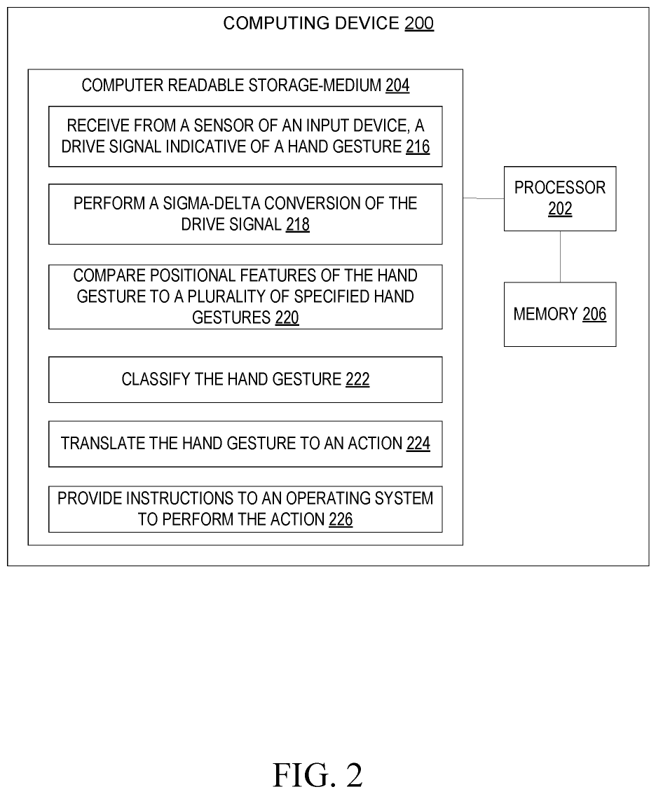

FIG. 2 illustrates an example block diagram of a computing device 200 including instructions for translating a hand gesture to an action, consistent with the present disclosure. The computing device 200 may include similar or different components as compared to computing device 100 illustrated in FIG. 1. Similar to computing device 100, computing device 200 includes a processor 202, a computer-readable storage medium 204, and a memory 206.

As illustrated in FIG. 2, the computer-readable storage medium 204 may store instructions 216 that when executed cause the processor 202 to receive from a sensor of an input device, a drive signal indicative of a hand gesture. As discussed with regards to FIG. 1, the sensor of the input device may include a projected capacitive array film, and a plurality of different hand gestures may be detected by the sensor. The sensor, or sensors, in the input device may continuously detect finger motion and positions and drive electrical signals to a bus at high rate.

The computer-readable storage medium 204 may include instructions 218 that when executed, cause the processor 202 to perform a sigma-delta conversion of the drive signal. As discussed with regards to FIG. 1, the drive signal from the sensor may be converted to a digital signal, such as using an ADC.

In various examples, the computer-readable storage medium 204 includes instructions 220 that when executed, cause the processor 202 to compare positional features of the hand gesture to a plurality of specified hand gestures corresponding with a hover mode of operation of the input device. As used herein, a positional features refers to or includes a hand position, a finger position, a combination of finger positions, a hand motion, a finger motion, a combination of finger motions, or combinations thereof. As discussed herein, a plurality of hand gestures may be customized and associated with different respective actions to be performed by the computing device 200.

The instructions 222, when executed, cause the processor 202 to classify the hand gesture as one of a plurality of specified hand gestures based on the comparison. For instance, as the sensor detects motion of a hand, the position of the hand, the position of each individual finger, and the motion of the hand and fingers are compared to the positional features of the specified hand gestures. If the detected hand gesture includes positional features that are also included in a specified hand gesture of the plurality of specified hand gestures, the associated action is performed by the computing device 200. Accordingly, the computer-readable storage medium 204 include instructions 224 that when executed, cause the processor 202 to translate the hand gesture to an action on a display communicatively coupled to the processor by determining a three-dimensional space position and a motion vector of the hand gesture. Positional features may be continuously detected by the sensor, such that a series of hand gestures may be detected. As an illustration, a user with a mouse coupled to a computing device may perform a plurality of different actions in series while using the mouse. In a similar manner, a series of hand gestures may be detected by the sensor while the input device is operating in the hover mode of operation. Each respective hand gesture may be detected by the sensor detecting the three-dimensional space position relative to the sensor, and a motion vector of the hand and/or fingers.

As discussed with regards to FIG. 1, the computer-readable storage medium 204 includes instruction 226 that when executed, cause the processor 202 to provide instructions to an operating system to perform the action.

In some examples, the computing device 200 may implement machine learning to improve the accuracy of the detection of hand gestures. For instance, the computer-readable storage medium 204 may include instructions that when executed cause the processor 202 to reclassify the hand gesture as a different one of the plurality of specified hand gestures responsive to user input. The reclassification of hand gestures may be in response to user input correcting the action that is associated with the hand gesture. Moreover, different and/or additional sensors may be used to improve the accuracy of correlating a detected hand gesture with an intended action. For instance, a sensor that monitors ocular movements may be incorporated in the computing device, and may be used to monitor the gaze of a user of the computing device. Gaze data may be used to learn the intended action associated with the hand gesture.

The hand gestures, and actions associated with each, may be fully customized by individual users. As an illustration, the hand gestures may be modified to indicate that the user is left-handed versus right-handed. As another illustration, variations of a same type of hand gesture may be correlated with a same action. For instance, a hand gesture including the positional features of a right thumb touching the tip of the right index finger may be associated with the left-click of a mouse. Similarly, a hand gesture including the positional features of the right thumb touching the right index finger at a position below the tip of the right index finger may also be associated with the left-click of the mouse and be considered a derivative of the same hand gesture. As such, a specified hand gesture among the plurality of specified hand gestures may include a derivative comprising a subset of positional features associated with the first specified hand gesture. In such examples, the instructions 222 to classify the hand gesture as one of a plurality of specified hand gestures based on the comparison further include instructions to classify the hand gesture as the derivative of the one of the plurality of specified hand gestures associated with the first specified hand gesture.

In some examples, the computer-readable medium 204 includes instructions that when executed, cause the processor 202 to map a thermal impulse received from the sensor to a three-dimensional space position and a motion vector for the hand gesture, determine from the three-dimensional space position and the motion vector, a finger position and motion for each finger of the hand gesture. Additional non-limiting examples of specified hand gestures include a start gesture, a stop gesture, a left click of a mouse, a left double-click of the mouse, a right click of the mouse, a start click-and-drag, an end click-and-drag, or combinations thereof. Additional and/or different hand gestures and associated actions may be provided by a user for customization. As such, new specified hand gestures may be provided by a user. In such examples, the computer-readable storage medium 204 may include instructions that when executed, cause the processor to receive user input associated with a new specified hand gesture, and use data received from a plurality of different types of sensors of the input device to generate a list of positional features associated with the new specified hand gesture.

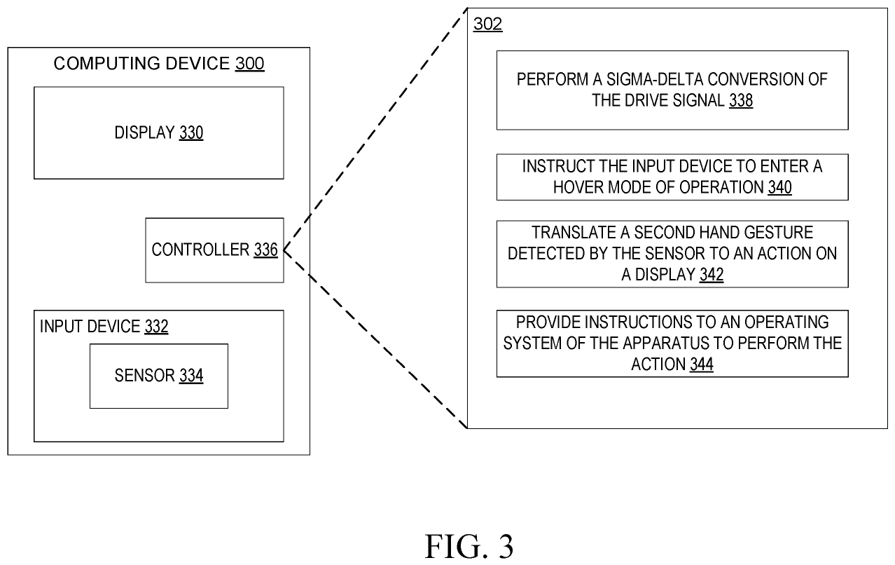

FIG. 3 illustrates an example apparatus 300, for translating a hand gesture to an action, consistent with the present disclosure. As illustrated, apparatus 300 includes a display 330, an input device 332 including a sensor 334, and a controller 336. In various examples, the controller 336 includes an ADC or DAC, as discussed with regards to FIG. 1. As described herein, the sensor 334 is to detect an electrical change indicative of a hand gesture, and responsive to the detection of the electrical change, produce a drive signal corresponding with the hand gesture.

The controller 336 may perform a plurality of steps responsive to detection of a hand gesture by the sensor 334. At 338, the controller 336 is to perform a sigma-delta conversion of the drive signal received from the input device 332. The signals received from the sensor are used to detect a particular hand gesture associated with a hover mode of operation. As such, at 340, the controller 336 is to instruct the input device 332 to enter a hover mode of operation in response to a determination that the hand gesture includes a first hand gesture. While in the hover mode of operation, the input device 332 is to detect additional hand gestures associated with a particular action to be taken by the computing device 300. At 342 the controller 336 is to translate a second hand gesture detected by the sensor 334 to an action on a display 330, and at 344 the controller 336 is to provide instructions to an operating system of the apparatus to perform the action.

In some examples, the sensor 334 is to detect an electrical change indicative of a third hand gesture, and the controller 336 is to instruct the input device 332 to exit the hover mode of operation, in response to the sensor 334 detecting the third hand gesture. For instance, a particular hand position and/or finger position may be associated with the action of exiting the hover mode of operation. The controller 336 may instruct the input device 332 to exit the hover mode of operation in response to the sensor 334 detecting the particular hand gesture associated with exiting the hover mode of operation. As a further example, the input device 332 may receive input from the keyboard indicative of a keypress from the user. In response to detecting keystrokes on the keyboard, the controller 336 may instruct the input device 332 to exit the hover mode of operation. As used herein, the designation of “first,” “second,” and “third,” (e.g., the first hand gesture, second hand gesture, third hand gesture, etc.) is use to distinguish different hand gestures from one another and does not imply an order of operation or use. Also, more, fewer, and/or different hand gestures may be used than those described here. The examples provided are for illustrative purposes only and do not limit the scope of the examples discussed.

In some examples, the sensor 334 includes a projected capacitive array film disposed on a substrate of the input device 332. For instance, the input device 332 is a keyboard, and the sensor 334 includes a projected capacitive array film disposed beneath the keyboard. Additionally and/or alternatively, the input device 332 may be a touchpad, a mouse, or other input device, and the sensor 334 includes a projected capacitive array film disposed within the touchpad, mouse, or other input device. The projected capacitive array film may be a self-capacitance array film, capable of measuring the capacitance of a single electrode with respect to ground. When a finger is near the electrode, the human-body capacitance changes the self-capacitance of the electrode. In a self-capacitance film, transparent conductors may be patterned into spatially separated electrodes in either a single layer or two layers. When the electrodes are in a single layer, each electrode represents a different touch coordinate pair and is connected individually to the controller 336. When the electrodes are in two layers, the electrodes may be arranged in a layer of rows and a layer of columns; the intersections of each row and column represent unique touch coordinate pairs.

Additionally and/or alternatively, the projected capacitive array film may be a mutual capacitance film array. With a mutual capacitive film array, if another conductive object, such as a finger, comes close to two conductive objects, the capacitance between the two objects changes because the human body capacitance reduces the charge. In both types of projected capacitive array films, to determine a location of the hand gesture, the values from multiple adjacent electrodes or electrode intersections may be used to interpolate the touch coordinates.

The projected capacitive array film disposed within the input device may be constructed by a plurality of different methods. For instance, the layers of the film may be deposited by sputtering, and micro-fine (e.g., 10 μm) wires can be substituted for the sputtered indium tin oxide (ITO). Patterning ITO on glass may be accomplished using photolithographic methods, for example, using photoresist on a liquid crystal display (LCD) fabrication. Additionally and/or alternatively, the substrate of the film may be polyethylene terephthalate, and patterning may be accomplished using screen-printing, photolithography, or laser ablation.

Conductor patterns may be etched in the projected capacitive array film in several different patterns. For example, conductor patterns may be etched in an interlocking diamond that consists of squares on a 45° axis, connected at two corners via a small bridge. This pattern may be applied in two layers—one layer of horizontal diamond rows and one layer of vertical diamond columns. Each layer may adhere to one side of two pieces of glass or PET, which may be combined, interlocking the diamond rows and columns.

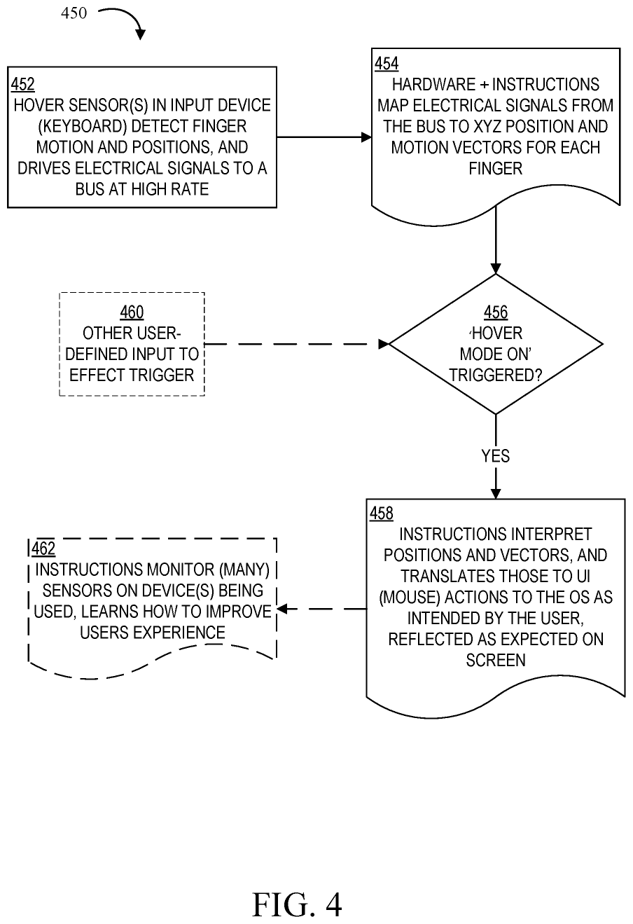

FIG. 4 illustrates an example flow diagram of a method 450, for translating a hand gesture to an action, consistent with the present disclosure. The processes illustrated in method 450, may be implemented by computing device 100, computing device 200, and/or computing device 300, as discussed herein.

As illustrated in FIG. 4, the method 450 may begin at 452. At 452, a sensor or sensors (also referred to as hover sensor(s)) in an input device such as a keyboard, detect finger motion and positions. Receiving the input is also described at 108 of FIG. 1 and 216 of FIG. 2. The sensor or sensors in the input device drive electrical signals to a bus at a high rate. The bus may be included in or communicatively coupled to, the controller 336 illustrated in FIG. 3.

At 454, hardware and instructions map electrical signals from the bus to XYZ (e.g., three-dimensional) positions and motion vectors for each finger. For instance, the controller 336 illustrated and discussed with regards to FIG. 3 may implement instructions to map the electrical signals, as discussed with regards to element 218 of FIG. 2, and element 338 of FIG. 3.

At 456, a decision is made whether hover mode is triggered. The determination as to whether the input device is to enter a hover mode of operation is discussed with regards to element 110 of FIG. 1, element 220 of FIG. 2, and element 340 of FIG. 3. If the hover mode of operation is triggered, the method 450 continues to 458, where instructions interpret positions and vectors, and translate those positions and vectors to user interface (UI) actions. The UI actions are translated to the operating system (OS) as intended (e.g., instructed) by the user, and the actions are reflected as expected on the screen of the computing device. Translation of hand gestures, including positions and vectors, into actions to be performed by the OS are described throughout this specification, such as with regards to elements 112 and 114 of FIG. 1, elements 220, 222, 224, and 226 of FIG. 2, and elements 342 and 344 of FIG. 3.

While examples of particular hand gestures are described for initiating the hover mode of operation, additional and/or different hand gestures may be used to initiate the hover mode of operation. For instance, each individual user may specify a particular hand gesture that the particular user associates with initiation of hover mode, and such user-defined input may affect the initiation (e.g., triggering) of the hover mode of operation at 460. Moreover, each user may interact with the computing device and instructions, to add additional hand gestures and improve the recognition of particular hand gestures. For instance, instructions executed by the computing device (e.g., computing device 100, computing device 200, and/or computing device 300) may receive signals from many sensors on the computing device. The signals from these sensors may interact with the user, such as by direct feedback from the user, to learn different and/or additional hand gestures and to improve the user experience, as illustrated at 462 and also discussed with regards to FIG. 2.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A computer-readable medium storing instructions that when executed cause a processor to:
receive from a sensor of an input device, a drive signal indicative of a hand gesture, wherein the drive signal is a sigma-delta A-to-D enabled drive signal;
instruct the input device to enter a hover mode of operation, in response to a determination that the hand gesture includes a first hand gesture;
translate a second hand gesture detected by the sensor to an action by determining a three-dimensional space position and a motion vector of the second hand gesture; and
provide instructions to an operating system to perform the action.

2. The medium of claim 1, wherein the first hand gesture includes a particular finger motion, and wherein the instructions to enter the hover mode of operation include instructions to initiate the hover mode of operation responsive to detecting the particular finger motion.

3. The medium of claim 1, wherein the input device includes a keyboard, the medium including instructions that when executed cause the processor to detect movement of a particular finger over a subset of keys of the keyboard.

4. The medium of claim 1, wherein the input device includes a keyboard, the medium including instructions that when executed cause the processor to provide instructions to the operating system to move a cursor on a display in a motion corresponding with the second hand gesture.

5. The medium of claim 1, wherein the second hand gesture includes a particular motion of a combination of fingers, including instructions that when executed cause the processor to select an object on a user interface on the display responsive to detecting the second hand gesture.

6. A computer-readable medium storing instructions that when executed cause a processor to:
receive from a sensor of an input device, a drive signal indicative of a hand gesture;
perform a sigma-delta conversion of the drive signal;
compare positional features of the hand gesture to a plurality of specified hand gestures corresponding with a hover mode of operation of the input device;
classify the hand gesture as one of a plurality of specified hand gestures based on the comparison;
translate the hand gesture to an action on a display communicatively coupled to the processor by determining a three-dimensional space position and a motion vector of the hand gesture; and
provide instructions to an operating system to perform the action.

7. The medium of claim 6, including instructions that when executed cause the processor to reclassify the hand gesture as a different one of the plurality of specified hand gestures responsive to user input.

8. The medium of claim 6, wherein each of the plurality of specified hand gestures include a plurality of positional features, and wherein a first specified hand gesture among the plurality of specified hand gestures includes a derivative comprising a subset of positional features associated with the first specified hand gesture.

9. The medium of claim 6, further including instructions that when executed cause the processor to:
map a thermal impulse received from the sensor to a three-dimensional space position and a motion vector for the hand gesture; and
determine from the three-dimensional space position and the motion vector, a finger position and motion for each finger of the hand gesture.

10. The medium of claim 6, wherein the plurality of specified hand gestures include a start gesture, a stop gesture, a left click of a mouse, a left double-click of the mouse, a right click of the mouse, a start click-and-drag, an end click-and-drag, or combinations thereof.

11. The medium of claim 6, including instructions that when executed cause the processor to:
receive user input associated with a new specified hand gesture; and
use data received from a plurality of different types of sensors of the input device to generate a list of positional features associated with the new specified hand gesture.

12. An apparatus, comprising:
an input device including a sensor, the sensor to:
detect an electrical change indicative of a hand gesture; and
responsive to the detection of the electrical change, produce a drive signal corresponding with the hand gesture; and
a controller to:
perform a sigma-delta conversion of the drive signal received from the input device;
instruct the input device to enter a hover mode of operation, in response to a determination that the hand gesture includes a first hand gesture;
translate a second hand gesture detected by the sensor to an action on a display; and
provide instructions to an operating system of the apparatus to perform the action.

13. The apparatus of claim 12, wherein the sensor is to detect an electrical change indicative of a third hand gesture, and wherein the controller is to instruct the input device to exit the hover mode of operation, in response to the sensor detecting the third hand gesture.

14. The apparatus of claim 12, wherein the sensor includes a projected capacitive array film disposed on a substrate of the input device.

15. The apparatus of claim 12, wherein the input device is a keyboard, and the sensor includes a projected capacitive array film disposed beneath the keyboard.
